(19) United States
(12) Patent Application Publication
(10) Pub. No.: US 2006/0182974 A1
(43) Pub. Date: Aug. 17, 2006

(54) Multi-layer sandwich materials with epoxide-based organic interlayers

(76) Inventors: Anne-Marie Garnault, Alligny-Cosne (FR); Marie-France Brouttier, Donzy (FR)

Correspondence Address: Daniel J. Harbison;Connolly, Bove, Lodge & Hutz, P.O. Box 2207, Wilmington, DE, 19899, US

(21) Appl. No.: 11/403,211

(22) Filed: Apr. 12, 2006

Related U.S. Application Data
(62) Division of application No. 10/450,279, filed on Nov. 17, 2003.

(30) Foreign Application Priority Data
Dec. 13, 2000 (DE) 100 62 009.4

(51) Int. Cl. B32B 27/38; B32B 15/08; B32B 37/00; C08L 63/00

(52) U.S. Cl. 428/416; 523/400

(57) ABSTRACT

Heat-hardened binder compositions based on at least one solid and/or liquid epoxide resin, a flexibilizing epoxide compound and an elastomer-modified epoxide resin as well as optionally latent hardeners are suitable for the production of multi-layer laminates, which consist of two outer metal plates and an interlayer of this binder matrix as well as optionally a flat material incorporated into the binder. These multi-layer laminates are suitable for the production of lightweight components for the construction of machinery, vehicles and tools and in particular for the construction of automobiles. Thus weight-optimized components with great strength and also optionally acoustic and/or reinforcing action can be produced.

### CROSS-REFERENCE TO RELATED APPLICATION

This application is a division of U.S. application Ser. No. 10/450,279, filed Jun. 11, 2003, which is a national stage application (under 35 U.S.C. 371) of PCT/EP01/14133, filed Dec. 4, 2001, which claims benefit to German application 100 62 009.4, filed Dec. 13, 2000.

### BACKGROUND OF THE INVENTION

The present invention relates to a multi-layer laminate of two outer metal plates and an interlayer containing an organic binder matrix and a process for producing this multi-layer laminate.

Multi-layer laminates and processes for the production of multi-layer laminates are widely used wherever there is a need to use specifically lightweight structures with a high level of strength and/or rigidity.

Specifically lightweight materials are used increasingly for the construction of machinery, vehicles and tools, in order to reduce the weight e.g. of the vehicles. For example, aluminum, fiber composites and also high-strength body steels are used. Whilst the use of ever stronger, ever thinner materials can fulfill the strength requirements in very many cases, it cannot fulfill the requirements for rigidity of components. Construction of ever thinner lightweight materials comes up against limitations above all wherever, for reasons of geometry, the reduced profile of the components means that they are no longer strong enough to meet the requirements of fitness for purpose. Examples of known multi-layer sandwich materials are web plates, hump and trapezoidal sandwich panels in their various forms. Geometric shapes produced by deformation, with an internal, supporting interlayer are the basis of the technical solutions for this type of lightweight construction. Suitable interlayers here, amongst others, are foam core fillings with polymeric foams or also with metallic foams or inorganic, silicate-based foams.

A three-layer sandwich material consisting of two cover plates and an interlayer of a visco-elastic material is preferred today for technical applications. Because of the relatively thin interlayer, which in general contributes very little to its rigidity, this type of sandwich panel is used mainly for its vibration-absorbing properties.

From DE-A-3905871 a sandwich material for heat and/or sound insulation is known, which on at least one side has a structurally strong covering layer of a thermally stable metal foil. As an insulating layer, a heat-resistant, highly porous, inorganic material is suggested, for example foamed glass with a sponge-like structure or porous concrete or foamed ceramic or mineral clay materials. A suggested use for these sandwich materials in the automotive field is for automobile exhausts.

From DE-A-3935120 a process for the production of multi-layer sandwich panels is known, in which the sandwich panel consists of a top and bottom plate, in between which is a web material of wire or a metal grid which, before it is bonded to the outer metal plates is deformed, flattening out the grid intersections. Enlarged bonding surfaces between the metal grid and the metal plates are thereby created, which will also allow forming. Whilst the specification states that the bonding of the metal grid with the cover plates can, in principle, be carried out by adhesion processes, it should preferably be carried out by welding processes. No further details of suitable adhesives can be obtained from this specification.

WO 00/13890 discloses glued multi-layer sandwich panels and processes for producing multi-layer sandwich panels, which consist of two outer metal plates, which serve as upper and lower base plates and which are bonded to a deformable connecting interlayer. Here, the deformable web material in the interlayer is bonded to the top and bottom plate by means of a foaming adhesive, which fills up the voids remaining in the sandwich. The web material between the metal plates can therefore consist of an expanded metal grid, a wire grid or a web plate and it can contain a multi-layer sequence of expanded metal grids, wire grids, web plates with intermediate plates which are impermeable or permeable to the adhesive. No suitable adhesive compositions are disclosed in this specification.

In view of this prior art, the objective of the inventors was to provide binders which are suitable for the production of multi-layer laminates, in particular for laminates which are composed of outer metal plates and an interlayer.

### SUMMARY OF THE INVENTION

The way in which the object of the invention is achieved can be seen from the claims, and substantially consists of the provision of multi-layer laminates, which can be produced from two outer metal plates and an interlayer of a binder matrix and optionally a flat material bonded into it, the binder composition containing at least one epoxide resin (a), one flexibilized epoxy compound (b) and an elastomer-modified epoxide resin (c).

### DETAILED DESCRIPTION OF THE PREFERRED EMBODIMENTS

In a particularly preferred embodiment, the binder is composed in such a way that it allows the production of weight-optimized, lightweight laminates with acoustic and/or reinforcing action. To achieve this, the binder system may contain for example chemical” foaming agents, or expandable or expanded microspheres.

The invention also relates to a process for the production of the above-mentioned multi-layer laminate, which contains the following substantial process steps:
a) application of the epoxide resin composition to be used according to the invention to a sheet-metal plate using a sheet die or a kiss-coating device,
b) optionally, application of the flat material to the epoxide resin composition,
c) joining of the second sheet-metal plate
d) optionally, moulding of the sandwich to the pre-determined spacing,
e) curing of the epoxide-adhesive interlayer by heating the sandwich to temperatures of 80° C.-250° C., preferably 160° C. to 200° C.

The last step e) can optionally be carried out in several stages. The binder composition can be pre-hardened in a first hardening stage. The multi-layer laminate can then be subjected to known forming and stamping processes, so that for example pre-formed bodywork components can be produced from the laminate, which are then joined together in a subsequent process step by conventional joining processes such as adhesion and/or welding, riveting, screwing, flanging. The final curing of the binder layer is then carried out in a subsequent process step e.g. in a lacquering oven after the electro-dipcoating of an unfinished vehicle bodyshell.

In another embodiment of the process according to the invention the binder composition is not applied directly to a sheet-metal plate, but to an intermediate substrate in a kind of “transfer process”. This intermediate substrate can be a sealing film with anti-adhesion properties, but it can also be the (reinforcing) flat material of the interlayer for the multi-layer laminate. In the latter embodiment, the binder layer for the interlayer can be provided with a sealing film which can optionally be removed before the binder-coated flat material is applied to the sheet-metal plate.

A variety of flexibilized epoxide resin compositions are suitable as the epoxide resin composition to be used according to the invention; the compositions mentioned in EP-A-354498, EP-A-591307, WO 00/20483, WO 00/37554 as well as the as yet unpublished applications DE 10017783.2 and DE 10017784.0 are mentioned by way of example. As already mentioned, the binder compositions to be used according to the invention contain at least one epoxide resin, a flexibilized epoxy compound and an elastomer-modified epoxide resin and generally also a latent hardener, which interlaces the binder when the composition is heated.

A variety of polyepoxides, which have at least 2 1,2-epoxy groups per molecule, are suitable epoxide resins. The epoxide-equivalent of these polyepoxides can vary from 150 to 50000, preferably from 170 to 5000. The polyepoxides can, in principle, be saturated, unsaturated, cyclic or acyclic, aliphatic, cycloaliphatic, aromatic or heterocyclic polyepoxide compounds. Examples of suitable polyepoxides include polyglycidyl ethers, which are produced by reacting epichlorohydrin or epibromohydrin with a polyphenol in the presence of alkali. Suitable polyphenols for this are for example resorcinol, catechol, quinol, bisphenol A (bis-(4-hydroxy-phenyl)-2,2-propane)), bisphenol F (bis(4-hydroxyphenyl)methane), bis(4-hydroxyphenyl)-1,1-isobutane, 4,4′-dihydroxybenzophenone, bis(4-hydroxyphenyl)-1,1-ethane, 1,5-hydroxynaphthaline. Other polyphenols suitable as a basis for the polyglycidyl ethers are the known condensation products of phenol and formaldehyde or acetaldehyde of the novolak resins type.

Other polyepoxides suitable in principle are the polyglycidyl ethers of polyalcohols or diamines. These polyglycidyl ethers are derived from polyalcohols such as ethylene glycol, diethylene glycol, triethylene glycol, 1,2-propylene glycol, 1,4-butylene glycol, triethylene glycol, 1,5-pentanediol, 1,6-hexanediol or trimethylolpropane.

Other polyepoxides are polyglycidyl esters of polycarboxyclic acids, for example reaction products of glycidol or epichlorohydrin with aliphatic or aromatic polycarboxylic acids such as oxalic acid, succinic acid, glutaric acid, terephthalic acid or dimeric fatty acid.

Other epoxides are derived from the epoxidation products of olefinically unsaturated cycloaliphatic compounds or from native oils and fats.

Most particularly preferred are epoxide resins which are derived from the reaction of bisphenol A or bisphenol F with epichlorohydrin, the liquid epoxide resins being preferably based on bisphenol A and having a sufficiently low molecular weight. The epoxide resins which are liquid at room temperature generally have an epoxide-equivalent weight of 150 to about 480; an epoxy-equivalent weight of 182 to 350 is preferred in particular.

Epoxide resins which are solid at room temperature can also be obtained from polyphenols and epichlorohydrin; those based on bisphenol A or bisphenol F with a melting point of 45° C. to 90° C., preferably 50° C. to 80° C. are preferred in particular. The latter differ from the liquid epoxide resins substantially by their higher molecular weight, as a result of which they become solid at room temperature. According to the invention, the solid epoxide resins have an epoxide-equivalent weight of >400; an epoxide-equivalent weight of 450 to about 900 is preferred in particular.

Reaction products of amino-terminated polyalkalyene glycols (Jeffamine from Huntsman) with an excess of liquid polyepoxides can be used as flexibilizing epoxide resins. Reaction products of this kind are disclosed in WO 93/00381 for example. Furthermore, the di- or trifunctional amino-terminated polyoxytetramethylene glycols, also known as poly-THF, are particularly suitable. In addition, amino-terminated polybutadienes are suitable as reaction components for epoxide resins which have a flexibilizing action, and also aminobenzoic acid esters of polypropylene glycols, polyethylene glycols or poly-THF (known by the commercial name “Versalink oligomeric Diamines” from Air Products). The amino-terminated polyalkylene glycols or polybutadienes have molecular weights of 400 to 6000. In principle, reaction products of mercapto-functional pre-polymers or liquid Thiokol polymers with an excess of polyepoxides can be used according to the invention as flexibilizing epoxide resins. The reaction products of polymeric fatty acids, in particular of dimeric fatty acids, or of difunctional polyesters containing carboxyl groups with epichlorohydrin, glycidol or in particular diglycidyl ethers of bisphenol A (DGEBA) are also preferred.

The flexibilized epoxy compound may be a reaction product of:

(i) a diglycidyl ether of bisphenol A with an amino-terminated polyoxyalkylene glycol, a dimeric fatty acid, a polyurethane prepolymer, an amino-terminated polyimide, a phenol-terminated polyimide, an amino-terminated polyamide, a phenol-terminated polyamide, or mixtures thereof;

(ii) a diglycidyl ether of bisphenol F with an amino-terminated polyoxyalkylene glycol, a dimeric fatty acid, a polyurethane prepolymer, an amino-terminated polyimide, a phenol-terminated polyimide, an amino-terminated polyamide, a phenol-terminated polyamide, or mixtures thereof; or

(iii) a glycidyl ether of a novolak resin with an amino-terminated polyoxyalkylene glycol, a dimeric fatty acid, a polyurethane prepolymer, an amino-terminated polyimide, a phenol-terminated polyimide, an amino-terminated polyamide, a phenol-terminated polyamide, or mixtures thereof.

Reaction products of the aforementioned di- or polyamines with a carboxylic acid hydride or polyanhydrid and a polyphenol or aminophenol with subsequent reaction of this intermediate with an epoxide resin, can also be used as flexibilizing epoxide resins. WO 00/37554 and the as yet unpublished DE 10017783.2 and DE 10017784.0 relate to such reaction products as flexibilizing additives for epoxide resin binders. The use of the reaction products with a flexibilizing action of the aforementioned type disclosed there are also expressly the subject matter of the epoxide resin binder compositions according to the invention.

A reaction product of an epoxide resin with a 1,3-diene-copolymer with polar comonomers, containing a carboxyl group, is used as an elastomer-modified epoxide resin. Butadiene, isoprene or chloroprene, preferably butadiene, can be used here as the diene. Examples of polar, ethylenically unsaturated comonomers are acrylic acid, methacrylic acid, lower alkyl esters of acrylic or methacrylic acid, for example their methyl or ethyl esters, amides of acrylic or methacrylic acid, fumaric acid, itaconic acid, maleic acid or their lower alkyl esters or semi-esters, or maleic acid or itaconic acid anhydride, vinyl esters such as for example vinyl acetate or in particular acrylonitrile or methacrylonitrile. Most particularly preferred coplymers are carboxyl-terminated butadiene acrylonitrile copolymers (CTBN), which are available in liquid form from B.F. Goodrich under the commercial name Hycar. These have molecular weights of 2000 to 5000 and acrylonitrile contents of 10% to 30%. Concrete examples are Hycar CTBN 1300×8, 1300×13 or 1300×15.

The elastomer-modified epoxide resin may be a reaction product of a diglycidyl ether of bisphenol A, a diglycidyl ether of bisphenol F or a glycidyl ether of a novolak resin with a copolymer containing carboxyl groups based on butadiene acrylonitrile, butadiene-acrylic acid esters, butadiene-methacrylic acid esters, a butadiene-acrylonitrile-styrene copolymer, a butadiene-acrylate-styrene copolymer, or a butadiene-acrylate-styrene copolymer.

Furthermore, the core/shell polymers known from U.S. Pat. No. 5,290,857 or U.S. Pat. No. 5,686,509 can also be used as diene copolymers. Here the core monomers should have a glass transition temperature of less than or equal to −30° C.; these monomers can be selected from the group of aforementioned diene monomers or suitable acrylate or methacrylate monomers, the core polymer may optionally contain small quantities of crosslinking comonomer units. The shell is constructed of copolymers which have a glass transition temperature of at least 60° C. The shell is preferably constructed of lower alkyl acrylate or methacrylate monomer units (methyl or ethyl esters) and polar monomers such as (meth)acrylonitrile, (meth)acrylamide, styrene or radically polymerizable unsaturated carboxylic acids or carboxylic acid anhydrides.

The binders to be used according to the invention may still contain so-called “reactive diluents”. According to this invention, reactive diluents are deemed to mean low-viscosity epoxy compounds which contain at least one epoxide group per molecule. These are, for example, the epoxide of vinyl benzene, the epoxide of monovinyl cyclohexane, epoxypentylether, epoxidated cyclohexenyl compounds, limonene-diepoxide, 2-vinyl-5,6-epoxybicycloheptane, 2-(1,2-epoxyethyl)-5,6-epoxybicycloheptane, 1,4-butanediol diglycidyl ether, Cardura E (from Shell), bis-(2,3-epoxy-2-methyl-propyl)ether, 2,3-epoxy-2-methyl propylethers of alkylene glycols, 3,4 epoxy-hexahydrobenzyl glycidyl ether, glycidyl ethers of C₇-C₁₅-alcohols, allylglycidyl ether, butylglycidyl ether, vinylglycidylether, styrene oxide and octylene oxide.

As the binders to be used according to the invention are preferably in single-component form and should harden in the presence of heat, they also contain a hardener and/or additionally one or more accelerators.

Guanidines, substituted guanidines, substituted ureas, melamine resins, guanamine derivatives, cyclical tertiary amines, aromatic amines and/or mixtures thereof can be used as heat-activated or latent hardeners for the epoxide resin binder system of components a), b) and c). Here the hardeners can either be included stochiometrically in the hardening reaction, or they can also be catalytically active. Examples of substituted guanidines are methyl guanidine, dimethyl guanidine, trimethyl guanidine, tetramethyl guanidine, methyl isobiguanidine, dimethyl isobiguanidine, tetramethyl isobiguanidine, hexamethyl isobiguanidine, heptamethyl isobiguanidine, and more particularly cyanoguanidine (dicyandiamide). Representatives of suitable guanamine derivatives are alkylated benzoguanamine resins, benzoguanamine resins or methoxymethyl-ethoxymethyl benzoguanamine. For the single-component, heat-hardened binders, the selection criterion is of course low solubility of these substances at room temperature in the resin system, so that solid, finely-ground hardeners are preferred; here dicyandiamide is suitable in particular. This ensures good storage stability of the composition.

In addition to or instead of the aforementioned hardeners, catalytically active substituted ureas can be used. These are, in particular, p-chlorophenyl-N,N-dimethyl urea (monuron), 3-phenyl-1,1-dimethyl urea (fenuron) or 3,4-dichlorophenyl-N,N-dimethyl urea (diuron). In principle, catalytically active tertiary aryl or alkyl amines can also be used, such as for example benzyldimethyl amine, tris(dimethylamino)phenol, piperidine or piperidine derivatives, although many of these have too high a level of solubility in the adhesive system so that no useful storage stability of single-component systems is achieved. Furthermore, various, preferably solid, imidazole derivatives can be used as catalytically active accelerators. 2-ethyl-2-methylimidazole, N-butylimidazole, benzimidazole and N—C₁ to C₁₂ alkylimidazoles or N-arylimidazoles are mentioned as substitutes for these. The use of a combination of hardener and accelerator in the form of so-called accelerated dicyandiamides in finely ground form is preferred in particular. This obviates the need for separate addition of catalytically active accelerators to the epoxide hardening system.

To achieve foaming during the hardening process, in principle all common foaming agents can be used; organic foaming agents from the class of azo compounds, N-nitroso compounds, sulfonyl hydrazides or sulfonyl semicarbazides are mentioned by way of example. Examples of the azo compounds to be used according to the invention are azobisisobutyronitrile and in particular azodicarbonamide, an example from the class of nitroso compounds is di-nitroso pentamethylene tetramine, examples from the class of sulfohydrazides are 4,4′-oxybis(benzene sulfonic acid hydrazide), diphenyl sulfon-3,3′-disulfohydrazide or benzene-1,3-disulfohydrazide, and an example from the class of semicarbazides is p-toluene sulfonyl semicarbazide. Foaming agents on a purely inorganic basis can also be used such as e.g. azides, carbonates or hydrogen carbonates in combination with solid acids and in particular the alkali metal silicate-based expandable foaming agents known from WO 95/07809 or U.S. Pat. No. 5,612,386.

Instead of the aforementioned foaming agents, the so-called “expandable microspheres” can also be used i.e. non-expanded thermoplastic polymer powders, which are impregnated or filled with low-boiling organic liquids. Such “microspheres” are disclosed for example in EP-A-559254, EP-A-586541 or EP-A-594598. Although not preferred, ready-expanded microspheres can also be used instead or as well. Optionally, these expandable/expanded microspheres can be combined with the above-mentioned “chemical” foaming agents in any proportion. The chemical foaming agents are used in expandable compositions in quantities of 0.1 to 3 wt. %, preferably 0.2 to 2 wt. %, the microspheres preferably in quantities of 0.1 to 4 wt. % preferably 0.2 to 2 wt. %.

The fillers can be selected from a variety of materials; chalks, naturally ground or precipitated calcium carbonates, calcium magnesium carbonates, silicates, heavy spar, graphite and black should be mentioned here in particular. Lamellar fillers such as e.g. vermiculite, mica, talc or similar phyllosilicates are suitable fillers. Concrete examples of silicate fillers are aluminum magnesium calcium silicates e.g. wollastonite or chlorite.

It may optionally be useful for at least some of the fillers to be surface pre-treated; in particular in the case of the various calcium carbonates or chalks, coating with stearic acid to reduce moisture introduced and to reduce the moisture-sensitivity of the hardened composition has proved useful.

In addition to the aforementioned inorganic fillers, fine-particle, thermoplastic polymer powders can also be used as fillers. Examples of suitable thermoplastic polymer powders are polypropylene, polyethylene, thermoplastic polyurethanes, (meth)acrylate- homo- or copolymers, styrene copolymers, polyvinylchloride, polyvinylacetates such as e.g. polyvinylbutyral, polyvinylacetate and copolymers thereof, in particular ethylene vinylacetate copolymers. These polymer powders typically have an average particle size of less than 1 mm, preferably less than 350 μm, most particularly less than 100 μm.

The compositions according to the invention generally also contain 1 to 15 wt. %, preferably 1.5 to 10 wt. % calcium oxide. The total proportion of fillers in the formulation can vary from 10 to 70 wt. %, the preferred range is from 25 to 60 wt. %. Here the resin (binder) to filler ratio is 40:60 to 80:20, preferably 70:30.

Conventional stabilizers such as e.g. sterically hindered phenols or amine derivatives can be used to counteract thermal, thermo-oxidative or ozone decomposition of the compositions according to the invention; typical quantity ranges for these stabilizers are 0.1 to 5 wt. %.

Although the rheology of the compositions according to the invention can normally be brought into the desired range through the selection of fillers and the proportions of lower molecular liquid polymers, conventional rheology auxiliary substances such as e.g. pyrogenic silicic acids, bentones or fibrilated or pulped short fibers in the range 0.1 to 7% can be added. Also, further conventional auxiliary substances and additives can be used in the compositions according to the invention.

The aim of the invention is to use the binders containing epoxide resin to produce specifically lightweight structures. They therefore contain, in addition to the aforementioned “normal” fillers, so-called lightweight fillers, which are selected from the group glass spheres, fly ash (fillite), plastic spheres based on phenol resins, epoxide resins or polyesters, ceramic spheres or organic lightweight fillers of natural origin such as ground nut shells, for example the shells of cashew nuts, coconuts or peanuts and cork powder or coke powder. Here, lightweight fillers based on microspheres are preferred in particular.

Expandable or expanded plastic microspheres based on polyvinylidene chloride copolymers are available commercially from Pierce & Stevens or Casco Nobel under the names Dualite or Espancel.

Furthermore, the adhesive compositions to be used according to the invention may contain further common auxiliary substances and additives such as e.g. plasticizers, reactive diluents, rheology auxiliary substances, wetting agents, adhesion agents, anti-ageing agents, stabilizers and/or paint pigments. Depending on the requirements profile of the multi-layer laminate with regard to its processing properties, flexibility, required reinforcing action, formability and adhesive bond to substrates, the proportions of the individual components may vary relatively widely. Typical ranges for the essential components are:

| | | | |
|---|---|---|---|
| (a) | solid epoxide resin | 25-50 | wt. % |
| (b) | liquid epoxide resin | 10-50 | wt. % |
| (c) | flexibilizing epoxide resin | 1 to 25 | wt. % |
| (d) | elastomer-modified epoxide resin | 2 to 10 | wt. % |
| (e) | reactive diluents | 0 to 5 | wt. % |
| (f) | hardeners and accelerators | 1.5 to 8 | wt. % |
| (g) | foaming agents | 0 to 5 | wt. % |
| (h) | lightweight fillers | 0-40 | wt. % |
| (i) | fillers | 5-20 | wt. % |
| (j) | fibers | 0-5 | wt. % |
| (k) | pigments | 0-1 | wt. % |

These binders have Severs viscosities of approximately 170 g/min (nozzle 4, 3 bar, 25° C.). They harden in 30 seconds to 15 minutes when heated to temperatures of 160° C. to 200° C., preferably in 1 to 3 minutes at 170° C.

A flat material is generally bound into the organic binder matrix of the interlayer of the laminate. A variety of materials can be used in principle for this flat material, for example “nonwovens”, fleeces, fabric, warp-knitted fabrics based on a variety of plastic fibers such as e.g. polyester fibers, polypropylene fibers, polyamide fibers, carbon fibers or also glass fibers. In a particularly preferred embodiment, these flat materials can consist of an expanded metal grid, a wire grid, a web plate or a perforated plate. Such metallic flat materials are known for example from WO 00/13890 or from DE-A-3935120. The flat materials named there for interlayers of multi-layer laminates expressly form part of this application.

Both of the outer metal plates of the laminates have a thickness of 0.1 to 0.5 mm, preferably 0.2 to 0.3 mm. These plates can be normal steel plates, but also steel plates processed by the various galvanization methods, for example electrolytically galvanized or hot-galvanized plates as well as the corresponding thermally post-treated or galvanized or subsequently phosphatized steel plates and aluminum plates.

The laminate has a total layer thickness of 1 mm to 2 mm, preferably 1.2 to 1.8 mm.

As mentioned at the beginning, the above-mentioned single component heat-hardened adhesive/sealant compositions are used for the production of multi-layer laminates, which are preferably used to produce unfinished bodyshells in the automobile industry. The compositions should harden in approximately 10 to 35 minutes at temperatures in the range 80° C. to 240° C., optionally in two stages. Temperatures of 160° C. to 200° C. are preferably used for the production of unfinished bodyshells. A decisive advantage of the compositions used according to the invention is that, here too, all advantages of the known epoxide-based adhesives/sealants can be utilized, i.e. they have good age-resistant adhesion to the various galvanized steels such as e.g. electrolytically galvanized, hot-galvanized and the corresponding thermally post-treated or galvanized and subsequently phosphatized steel plates as well as un-galvanized steels and aluminum, even if the substrates are still coated in the various anti-corrosion and/or deep-drawing oils.

The following exemplary embodiments are intended to explain the invention further, and the choice of examples is not intended to represent a restriction of the subject matter of the invention, but only to illustrate concrete embodiments in model form. Unless otherwise stated, all quantities for the compositions are given by weight.

### EXAMPLES

Two binder compositions based on epoxide resins were used to produce multi-layer laminates according to the invention.

Binder 1:

| | |
|---|---|
| Epoxide resin based on bisphenol A and epichlorohydrin | 51.6 |
| (DGEBA) | |
| Flexibilized epoxide resin (ester-epoxide resin, chain- | 11.4 |
| lengthened, difunctional, epoxide equivalent 480) | |
| Elastomer-modified epoxide resin based on epichlorohydrin/ | 7.0 |
| bisphenol F, modified with a “toughening agent”, epoxide | |
| equivalent 198, viscosity at 100° C. 300 mPa/s (cone/plate) | |
| Dicyandiamide | 7.1 |
| calcium carbonate (ground chalk) | 13.9 |
| calcium oxide | 4.5 |
| accelerators (epoxide resin-amine adduct, imidazole-modified | 3.0 |
| reactive diluent (monoglycidyl ether isomers C₁₃/C₁₅ | 1.5 |
| alkylalcohols) | |

Binder 2:

| | |
|---|---|
| DGEBA | 34.0 |
| flexibilized epoxide resin | 8.0 |
| elastomer-modified epoxide resin | 5.0 |
| Dicyandiamide | 4.5 |
| Chalk | 9.0 |
| Talcum | 30.0 |
| iron oxide (pigment) | 4.5 |
| calcium oxide | 3.0 |
| Accelerator | 1.0 |
| reactive diluent | 1.0 |

The aforementioned binders were applied to a polypropylene fabric. This coated fabric was then pressed on each side with two 0.25 mm thick steel plates and the laminate thus formed was hardened. The multi-layer laminates produced in this way had excellent properties in the 3-point or 4-point bending test under DIN 53293.

What is claimed is:

1. A multi-layer laminate comprising two outer metal plates and an interlayer comprising a binder matrix, wherein the binder matrix comprises at least one epoxide resin, at least one flexibilized epoxy-compound and at least one elastomer-modified epoxide resin, and wherein the interlayer further comprises at least one flat material incorporated into the binder matrix.

2. The multi-layer laminate of claim 1, wherein the at least one epoxide resin is a diglycidyl ether of bisphenol A, a diglycidyl ether of bisphenol F or a glycidyl ether of a novolak resin.

3. The multi-layer laminate of claim 2, wherein the at least one flexibilized epoxy compound is a reaction product of: (i) a diglycidyl ether of bisphenol A with an amino-terminated polyoxyalkylene glycol, a dimeric fatty acid, a polyurethane prepolymer, an amino-terminated polyimide, a phenol-terminated polyimide, an amino-terminated polyamide, a phenol-terminated polyamide, or mixtures thereof; (ii) a diglycidyl ether of bisphenol F with an amino-terminated polyoxyalkylene glycol, a dimeric fatty acid, a polyurethane prepolymer, an amino-terminated polyimide, a phenol-terminated polyimide, an amino-terminated polyamide, a phenol-terminated polyamide, or mixtures thereof; or (iii) a glycidyl ether of a novolak resin with an amino-terminated polyoxyalkylene glycol, a dimeric fatty acid, a polyurethane prepolymer, an amino-terminated polyimide, a phenol-terminated polyimide, an amino-terminated polyamide, a phenol-terminated polyamide, or mixtures thereof.

4. The multi-layer laminate of claim 2, wherein the at least one elastomer-modified epoxide resin is a reaction product of a diglycidyl ether of bisphenol A, a diglycidyl ether of bisphenol F or a glycidyl ether of a novolak resin with a copolymer containing carboxyl groups based on butadiene acrylonitrile, butadiene-acrylic acid esters, butadiene-methacrylic acid esters, a butadiene-acrylonitrile-styrene copolymer, a butadiene-acrylate-styrene copolymer, or a butadiene-acrylate-styrene copolymer.

5. The multi-layer laminate of claim 1, wherein the binder matrix contains at least one hardening accelerator, at least one latent hardener, or mixtures thereof, wherein the latent hardener is selected from the group consisting of guanidines, substituted guanidines, substituted ureas, melamine resins, guanamine derivatives, cyclic tertiary amines, aromatic amines, and mixtures thereof.

6. The multi-layer laminate of claim 1, wherein the binder matrix contains at least one thermoplastic polymer powder having an average particle size of less than 1 mm, and the at least one thermoplastic polymer is selected from the group consisting of vinylacetate homopolymers, vinylacetate copolymers, ethylene vinylacetate copolymers, vinylchloride homopolymers, vinylchloride copolymers, styrene homopolymers, styrene copolymers, acrylate homopolymers, acrylate copolymers, methacrylate homopolymers, methacrylate copolymers, polyvinylbutyral, and mixtures thereof.

7. The multi-layer laminate of claim 1, wherein the binder matrix contains at least one foaming agent.

8. The multi-layer laminate of claim 1, wherein each metal plate has a thickness of 0.1 to 0.5 mm.

9. The multi-layer laminate of claim 1, wherein the at least one flat material is an expanded metal grid, a wire grid, a web plate or a perforated plate.

10. The multi-layer laminate of claim 1, wherein the at least one flat material has a thickness of 0.7 to 1.2 mm.

11. The multi-layer laminate of claim 1, wherein the flat material and the two outer metal plates are connected by an electrically conductive connection.

12. The multi-layer laminate of claim 1, wherein the multi-layer laminate has a total thickness of from 1 mm to 2 mm.

13. A process for making a multi-layer laminate, comprising: providing a first sheet-metal plate, wherein the first sheet-metal plate has a top surface; applying a binder matrix to the top surface of the first sheet-metal plate, wherein the binder matrix comprises at least one epoxide resin, at least one flexibilized epoxy-compound and at least one elastomer-modified epoxide resin; joining a second sheet-metal plate to the binder matrix to form the multi-layerlaminate; applying a flat material to the binder matrix before the second sheet-metal plate is joined, and curing the binder matrix by heating the multi-layer laminate to a temperature of from 80° C. to 250° C.

14. The process of claim 13, wherein the multi-layer laminate is compressed to a predetermined thickness prior to curing.

15. The process of claim 13, wherein the curing step comprises: pre-hardening the binder matrix in a first hardening stage; forming or stamping the multi-layer laminate; and fully curing the binder matrix in a final hardening stage.

16. The process of claim 13, wherein the at least one epoxide resin is a diglycidyl ether of bisphenol A, a diglycidyl ether of bisphenol F or a glycidyl ether of a novolak resin.

17. The process of claim 13, wherein the at least one flexibilized epoxy compound is a reaction product of:
(i) a diglycidyl ether of bisphenol A with an amino-terminated polyoxyalkylene glycol, a dimeric fatty acid, a polyurethane prepolymer, an amino-terminated polyimide, a phenol-terminated polyimide, an amino-terminated polyamide, a phenol-terminated polyamide, or mixtures thereof;
(ii) a diglycidyl ether of bisphenol F with an amino-terminated polyoxyalkylene glycol, a dimeric fatty acid, a polyurethane prepolymer, an amino-terminated polyimide, a phenol-terminated polyimide, an amino-terminated polyamide, a phenol-terminated polyamide, or mixtures thereof; or
(iii) a glycidyl ether of a novolak resin with an amino-terminated polyoxyalkylene glycol, a dimeric fatty acid, a polyurethane prepolymer, an amino-terminated polyimide, a phenol-terminated polyimide, an amino-terminated polyamide, a phenol-terminated polyamide, or mixtures thereof.

18. The process of claim 13, wherein the at least one elastomer-modified epoxide resin is a reaction product of a diglycidyl ether of bisphenol A, a diglycidyl ether of bisphenol F or a glycidyl ether of a novolak resin with a copolymer containing carboxyl groups based on butadiene acrylonitrile, butadiene-acrylic acid esters, butadiene-methacrylic acid esters, a butadiene-acrylonitrile-styrene copolymer, a butadiene-acrylate-styrene copolymer, or a butadiene-acrylate-styrene copolymer.
